(19) United States
(12) Patent Application Publication
(10) Pub. No.: US 2018/0268558 A1
(43) Pub. Date: Sep. 20, 2018

(54) METHOD AND SYSTEM FOR RECORDING A CHANGE IN POSITION OF AN OBJECT

(71) Applicant: Siemens Healthcare GmbH, Erlangen (DE)

(72) Inventors: Christoph BAUER, Nuernberg (DE); Vittorio COLOMBO, Fuerth-Poppenreuth (DE)

(73) Assignee: Siemens Healthcare GmbH, Erlangen (DE)

(21) Appl. No.: 15/921,830

(22) Filed: Mar. 15, 2018

(30) Foreign Application Priority Data
Mar. 20, 2017 (EP) 17161766.5

(51) Int. Cl. G06T 7/246; G06T 7/00; G06T 7/254

(52) U.S. Cl. CPC G06T 7/248; G06T 15/08; G06T 7/254; G06T 7/0016

(57) ABSTRACT

A method and a system are for recording a change in position of an object. In an embodiment, a diagnostic image of the object in a scan position is generated with an imaging medical method. After the generation of the diagnostic image, a camera image of the object is recorded in a current position from a perspective with a specified spatial positional relationship to the diagnostic image. Correlation of the diagnostic image and the camera image is used to determine a deviation of the current position of the object from a setpoint position defined relative to the scan position.

### PRIORITY STATEMENT

The present application hereby claims priority under 35 U.S.C. § 119 to German patent application number EP 17161766.5 filed Mar. 20, 2017, the entire contents of which are hereby incorporated herein by reference.

### FIELD

At least one embodiment of the invention generally relates to a method and/or a system for recording a change in position of an object. At least one embodiment of the invention is in the field of medical imaging methods and further measures based thereupon, such as, for example, preparation for radiotherapy applications.

### BACKGROUND

A common procedure used nowadays in this field of application is to use a diagnostic image of a patient to determine a location in the patient at which, for example, therapeutic radiation is to arrive or impinge or at which a mark is to be applied for the later verification of a position or posture of the patient. It is also, for example, possible for a reference point to be marked appropriately on the patient, for example on an anatomically stable point. This location is then marked on the patient, wherein, however, a change in position of the patient between the recording of the diagnostic image and the marking can result in an unrecognized error.

The system AlignRT made by the company Vision RT Ltd. utilizes a laser projector to project a grid onto the patient and two cameras for recording a reference image and for the later recording of a comparative image of the patient. A comparison of these images can be used to determine a change in position of the patient from a change in the projected grid. This then enables a therapist to realign the patient. However, nowadays, in the case of a recognized or suspected change in position, a new diagnostic image is created in the hope that the patient does not move or at least moves to a lesser degree. This disadvantageously increases the dose to which the patient is exposed.

### SUMMARY

At least one embodiment of the present invention enables a change in position of an object reliably and for a particularly low outlay.

Advantageous embodiments and developments of the invention are disclosed in the claims, the description and the drawings.

With the method according to at least one embodiment of the invention for recording a positional relationship of an object, first a diagnostic image of the object in a scan position is generated with an imaging medical method. After the generation of the diagnostic image, a camera image of the object in a current position is recorded. Herein, the camera image is recorded from a perspective with a specified spatial positional relationship to the diagnostic image and/or to an image-generating facility used to record the diagnostic image—or the raw data on which this is based. Correlation between the diagnostic image and the camera image is then used to determine a deviation of the current position of the object from a setpoint position of the object defined relative to the scan position.

A system of at least one embodiment is for recording a change in position of an object. In at least one embodiment, the system comprises a control device, an image-generating facility, a camera arranged in a specified spatial positional relationship to the image-generating facility and a data-processing facility, wherein the control device is configured to
control the image-generating facility for the generation of a diagnostic image of the object in a scan position with an imaging medical method, and
to control the camera for the recording of a camera image of the object in a current position after the generation of the diagnostic image and
to control the data-processing facility for the determination of a deviation of the current position of the object from a setpoint position defined relative to the scan position by a comparison of the diagnostic image and the camera image.

### BRIEF DESCRIPTION OF THE DRAWINGS

Further features, details and advantages of the present invention can be derived from the subsequent description of preferred example embodiments and with reference to the drawings, in which:

FIG. 1 shows a schematic perspective view of an imaging medical device and of a patient to be imaged therewith in a scan position;

FIG. 2 shows a schematic representation of a scan representation generated via the medical imaging device of the patient with a virtual mark;

FIG. 3 shows the representation from FIG. 1, wherein the patient is located in a current position after a scan with the medical imaging device and a camera image of the patient is recorded; and

FIG. 4 shows a schematic comparison of a diagnostic image generated with the medical device and a camera image of the patient in each case with virtual marks.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java, Fortran, Perl, Pascal, Curl, OCaml, Javascript, HTML5, Ada, ASP (active server pages), PHP, Scala, Eiffel, Smalltalk, Erlang, Ruby, Flash, Visual Basic, Lua, and Python.

Further, at least one embodiment of the invention relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

With the method according to at least one embodiment of the invention for recording a positional relationship of an object, first a diagnostic image of the object in a scan position is generated with an imaging medical method. After the generation of the diagnostic image, a camera image of the object in a current position is recorded. Herein, the camera image is recorded from a perspective with a specified spatial positional relationship to the diagnostic image and/or to an image-generating facility used to record the diagnostic image—or the raw data on which this is based. Correlation between the diagnostic image and the camera image is then used to determine a deviation of the current position of the object from a setpoint position of the object defined relative to the scan position.

The object can preferably be a patient. Accordingly, at least one embodiment of the invention is explained below using this example. However, this does not restrict embodiments of the invention to an application for recording a change in position of a patient since any subject matter can serve or be used as an object.

The diagnostic image can, for example, be an X-ray, computed tomography or magnetic resonance tomography image or the like. The generation of the diagnostic image can include acquiring or recording the image or the raw data or image data on which this is based and, if required, data processing and/or provision of the diagnostic image. Herein, the scan position is the real position or site of the object in which it is located or was located during the generation of the diagnostic image, in particular during the recording of the raw data or image data on which the diagnostic image is based. Therefore, the scan position can in particular be defined or specified relative to the image-generating facility used to record this data, for example, therefore, relative to a CT or MRI device used.

The camera image can be acquired or recorded via a camera. Herein, the camera image can depict the object in an optical or visible frequency range or spectral range, but it can also be possible for the camera image additionally or alternatively to use other, for example non-visible, frequency ranges or spectral ranges. Here, for example, a skillful choice according to the nature or condition, in particular, for example, according to the surface condition or reflectivity, of the object can achieve greater precision of the camera image and/or enhanced depiction or identifiability of the object in the camera image. The camera used to record the camera image can preferably be arranged or fixed on the image-generating facility used for the diagnostic image.

The camera can be positioned rigidly or held in a movable manner. In the former case, herein advantageously a consistent spatial positional relationship between the camera and the image-generating facility is ensured. In the latter case, it is, for example, possible for a sensing mechanism or recording facility to be provided to track or determine a respective position or site or location of the camera relative to the image-generating facility.

Thus, it is possible to ensure that the diagnostic image and the camera image can be positioned relative to one another in a consistent manner. This is in particular important when the diagnostic image and the camera image depict the object from different perspectives and/or when, at the time of the recording of the camera image, the camera is situated at a location different from that of the image-generating facility at the time of the generation or recording of the diagnostic image or the image data for the diagnostic image.

The setpoint position is a position or site of the object that the object would adopt at the time of the recording of the camera image if there had been no movement, or no movement in an uncontrolled or unplanned manner, in particular no movement in a manner not specified or envisaged by a therapist or technician between this time and the time of the recording of the image data for the diagnostic image. Herein, the setpoint position can correspond to the scan position. However, it is also, for example, possible for a table or bench on which the patient may be lying during the CT or MRI scan to be moved, adjusted or displaced in a controlled manner after this scan. This can for example mean that it is not necessary for the patient to remain inside the tube of the CT or MRI device, which is often perceived as unpleasant.

It is correspondingly also possible for the image-generating facility, i.e., for example, the CT or MRI device, to be moved or displaced relative to the patient. Hence, this results in a controlled and known spatial positional relationship between the scan position and the setpoint position. Herein, an arrangement of the patient or the object in a setpoint position different from the scan position can, for example, have the advantage that the camera image can be recorded in a particularly simple manner and from an optimal perspective and/or that it is particularly easy to access or reach the object or the patient for further procedures or treatment steps.

If the patient has moved between the recording times of the image data for the diagnostic image and the recording times of the camera image, this can be determined, i.e. identified or established, by the envisaged comparison or correlation of the diagnostic image and the camera image. With previous methods, a respective technician attempts, for example, to identify such a movement, i.e. change in position, of the patient independently by visual means. On the other hand, in the present case, it can preferably be provided that it is automatically determined whether such a deviation exists, i.e. whether the patient has moved correspondingly. To this end, it is, for example, automatically possible to calculate a difference or a difference image between the diagnostic image and the camera image. For this, it can in particular be provided that the diagnostic image and the camera image have the same number of dimensions, i.e. for example, that both are 2D images or both are 3D images.

In an example embodiment of the invention, the diagnostic image can, for example, be generated by recording three-dimensional scan data of the object and a subsequent virtual three-dimensional reconstruction of the object or a representation of the object based on the scan data. Preferably, then the camera image is also recorded as a 3D image of the object. Known volume rendering techniques (VRT) can be used to generate the three-dimensional diagnostic image. It is, for example, possible to use a stereoscopic or 3D camera to record the three-dimensional camera image. However, it is also, for example, possible only to use a two-dimensional sectional view as a diagnostic image and a conventional two-dimensional image or photograph as a camera image.

Additionally or alternatively to determining the difference between the diagnostic image and the camera image, it is advantageously possible to use automatic image recognition in order to identify points or regions that correspond to one another in the diagnostic image and in the camera image. Since respective real spatial regions recorded or depicted by the diagnostic image and the camera image are, directly or via the known setpoint position, in a known spatial relationship to one another, it is then possible, to determine the deviation, for example by a comparison of respective pixel or voxel coordinates of points or regions corresponding to one another in the diagnostic image and the camera image. One possibility for finding such points or regions that correspond to one another can be the provision of a correspondingly trained neural network in the automatic processing of the diagnostic image and the camera image.

Therefore, at least one embodiment of the present method provides that the generated diagnostic image in conjunction with the camera image recorded after the diagnostic image can be used for the determination of any deviation, i.e. change in position of the object, that may be present. Herein, it is advantageous that, for example, it is possible to dispense with a projector—as used with the described conventional known procedures—for the projection of a grid onto the patient. This not only reduces or saves outlay on equipment, calibration and costs, it also avoids any possible irritation on the part of the patient from the laser light used for the projection of the grid. Similarly—since the image data of the diagnostic image are anyway recorded and generated and inevitably depict the object exactly in the scan position—the change in position can be determined without additional steps, for example for the separate recording of a reference image. Since, therefore, it is possible to save on the time needed for the recording of the reference image and the adjustment of the projector or the projected grid, the present method can advantageously minimize the time required to examine, treat or prepare the patient.

Moreover, the use of the diagnostic image has the advantage that not only the position or site of the entire patient or a surface or contour of the patient can be used for the determination or recording of the change in position. Instead, the diagnostic image can be used to evaluate and use an actually and truly relevant position or change in position of an internal region of the patient, for example a tumor to be treated or the like. Herein, the diagnostic image can, for example, determine a position of this relevant internal region of the object or the patient relative to the outer surface or contour of the object or the patient.

It is, for example, possible for the patient to move and, at the same time, for the relevant internal region to remain in its setpoint position or deviate to a different degree therefrom than, for example, an outer surface region of the patient. The camera image can then, for example, also be used to determine not only a position or attitude of the entire patient or an outer surface or contour of the patient, but for example a position or site of a structure of the patient, for example one or more bones or joints. From this, it is, for example, also possible to draw conclusions regarding a position or attitude of the internal region since this can, for example, be arranged in a fixed or known spatial relationship to this structure or these structures or can be movable.

Overall, therefore, at least one embodiment of the present invention enables the determination of the change in position, in particular the change in position relevant in each case, with a particularly low outlay on equipment and time and simultaneously improved accuracy or precision. This can, for example, contribute to an improved treatment outcome in subsequent treatment steps.

The change in position, i.e. the deviation between the current position of the object and the setpoint position, can preferably be made visually identifiable. To this end, it is, for example, possible for the diagnostic image and the camera image to be displayed via a display facility, for example a screen or a projection facility. Preferably, this display facility can be arranged on the image-generating facility, i.e. for example on the CT or MRI device or at least within the same room as the image-generating facility. This advantageously enables the respective therapist or technician carrying out the treatment to reposition the object or the patient particularly reliably in accordance with the determined change in position or deviation.

In a particularly preferred embodiment, the change in position or the deviation can be displayed by way of virtual or augmented reality. For example, it is possible to use a head-mounted-display (HMD) by which, for example, the setpoint position of the object can be displayed additionally to or superimposed on the current position. This enables particularly precise positioning of the object in the setpoint position. Contrary to this, previous methods are based on an estimation or visual judgment of the technician carrying out the treatment, wherein typically relatively small deviations are not identified.

The visualization of the deviation or the setpoint position suggested in the present case can ensure that repositioning of the object causes it to be actually transferred or moved into the setpoint position. It is additionally or alternatively possible to provide an audible indication of the deviation. Herein, it is for example possible to indicate a direction or type, i.e. for example a red rotational or translational difference and/or an extent, i.e. an amount or a size, of the deviation, for example, by different pitches and/or volumes. To this end, it is, for example, possible for a control device to be provided to control the HMD and/or speaker as a function of the deviation determined. Herein, the visualization and/or the audible indication of the deviation can be adjusted continuously.

In a preferred embodiment of the invention, to this end, in addition to the one camera image, a plurality of further camera images, in particular a video sequence or a continuous video stream, of the object can be recorded. The deviation can then, in particular in real time, be determined continuously by correlation between the diagnostic image and the plurality of further camera images, in particular the video sequence. The further camera images or the video sequence can therefore be used to determine or update the current position of the object continuously. To this end, the camera for recording the camera image can be a video camera.

However, it is also possible, additionally to arrange one or more video cameras on the image-generating facility or in a known or specified spatial positional relationship relative to the camera and/or to the image-generating facility. This can optionally be used to record the current position of the object from viewing angles or perspectives, thus then also enabling continuous recording of the current position of the object when, for example, a field of view of a camera is wholly or partially masked.

The use of virtual and/or augmented reality can advantageously enable or offer direct, i.e. immediately identifiable, visual feedback for repositioning or re-alignment of the object. Herein, particularly advantageously all the data required for correct repositioning is contained in a common representation or view. This advantageously enables the avoidance of the need for the respective technician to keep glancing between one screen and the other during the repositioning of the object or even to leave the room in which the object is located in order to read or reproduce the setpoint position.

In an advantageous embodiment of the present invention, the deviation determined is automatically compensated. This can in particular take place by moving an object holder supporting the object and/or by moving a marking facility—for example a marking laser—for marking the object as a function of the deviation determined. In other words, therefore, an adjusting mechanism, for example a servomotor or stepping motor, for adjusting or moving the object holder and/or the marking facility can be provided. In other words, a relative movement is automatically effected as a reaction to a determined or identified deviation, i.e. a change in position of the object.

The object holder can, for example, be a bench or a patient table on which the patient is lying or arranged during the recording of the image data for the diagnostic image. The marking facility can, for example, be a laser provided as part of or on the image-generating facility by which a specific location, for example identified in the diagnostic image, can be displayed in reality on the patient. Alternatively or additionally, the marking facility can, for example, be arranged in the same room as the object holder. For example, one or more marking lasers can be arranged on the ceiling or wall of a room. Herein, the marking facility can in particular be arranged in a known, optionally reproducible variable, spatial positional relationship to the image-generating facility and/or to the camera or relative to a common coordinate system.

Herein, the possibility of moving both the object holder and the marking facility, in particular independently of one another is particularly advantageous, since this achieves a greater degree of flexibility. For example, a possible travel path or degree of adjustment of the object holder and/or the marking facility can be limited so that relatively high deviations cannot be compensated solely by adjusting or moving the object holder or the marking facility since, for example, an end position has been reached. In such a case, the deviation can be compensated by adjusting both the object holder and the marking facility.

In addition, the object holder and the marking facility can have wholly or partially different degrees of freedom, i.e. for example different directions and/or adjusting modes. For example, the marking facility can be held on a circular path rotatably about a longitudinal axis or direction of the object holder. This enables reliable compensation of the deviation in a particularly large number of different situations.

It can be provided as one possible implementation that the diagnostic image or a representation of the diagnostic image is correspondingly, i.e. as a function of the deviation determined, virtually displaced or adjusted. This can also be performed automatically by an operator. In the latter case, the movement or adjustment induced by the operator can be recorded automatically. A control signal can be generated as a function of the movement or adjustment of the diagnostic image or the representation thereof and supplied to the marking facility and/or the object holder.

As a function of or in accordance with the control signal, the marking facility can then be automatically adjusted into a correct position and/or the object holder moved. This effectively results in a relative movement, in particular between the patient and the marking facility so that the intended location is or can be marked on the patient by the marking facility.

If it is intended to record further camera images, for example the video sequence or the video stream, the object holder and/or the marking facility can be continuously controlled or moved in order to carry out continuous tracking of the object holder and/or the marking facility. Therefore, the continuously determined deviation can be continuously automatically compensated.

In an advantageous embodiment of the present invention, the deviation is only automatically compensated when it exceeds a specified threshold value. Herein, the threshold value can, for example, be defined by a therapist or technician individually or depending upon the situation. It is also possible for the threshold value to be selected or defined automatically.

To this end, it is, for example, possible to hold resident a characteristics map or an assignment table specifying the threshold value to be used in each case for example for different situations, therapeutic strategies, devices or facilities used or the like. It is also, for example, possible for the threshold value to be specified or determined by a positioning accuracy achievable with the respective devices or facilities or corresponding tolerances.

The use of such a threshold value enables the avoidance of an unnecessary movement or adjustment. This advantageously enables savings to be made on the adjustment time required for a corresponding movement or adjustment.

In addition, it is also, for example, advantageously possible to avoid continuous to-and-fro movements of the object holder and/or the marking facility, which without the threshold value could, for example, further adjust itself to compensate respiratory motions of the patient or the like. This advantageously enables the avoidance of unnecessary loading and hence unnecessary wear on the corresponding devices, facilities or adjusting mechanisms and increases patient comfort. For example, a deviation of about 5 mm can be specified as a threshold value.

Herein, the threshold value can be specified for a deviation in a dimension or direction or for a resulting overall deviation or overall direction. It is also possible, for example, for different threshold values to be specified for different directions or dimensions. This advantageously enables, for example, different directional properties, for example of therapeutic radiation, to be taken into account.

Additionally or alternatively to the threshold value it is, for example, possible for irrelevant subregions of the object to be defined or corresponding definitions to be specified or recorded. For example, a movement or change in position of the head of the patient can be irrelevant, i.e. insignificant for planned treatment on the hip or on a leg of the patient. It is then possible to ignore deviations determined in irrelevant regions. This advantageously, for example, enables the avoidance of an unnecessary adjustment and hence also the risk of a respective relevant region being moved. Thus, it is, for example, possible to avoid or resolve a conflict when it is not possible to move all the subregions of the patient into their respective setpoint positions.

In an advantageous embodiment of the present invention, a first virtual mark in the diagnostic image is recorded. Herein, this first virtual mark indicates a specified setpoint location for a real mark on the object in a coordinate system of the diagnostic image. The camera image is aligned on the same or a corresponding coordinate system, which is also used for the diagnostic image, wherein a second virtual mark in the camera image is displayed at a location of first virtual mark in the coordinate system. In other words, therefore, the first and second virtual mark can mark the same location in both the diagnostic image and the camera image based on the respective coordinate system, in particular independently of the image content. Therefore, the first virtual mark does not necessarily mark or display the same location of the patient as the second virtual mark, since the patient can have moved relative to the coordinate system or possibly relative to a field of view or recording region of the camera and/or the image-generating facility. For example, the origin of the coordinate system, i.e. its zero point can, for example, be located in each case in the center of the diagnostic image or the camera image or, for example, in a respective bottom left corner. I.e. the coordinate system correlates with the respective image section or real recording region.

If there is a change in position of the object between the recording times of the diagnostic image and of the camera image, this means there is no displacement of the respective image section or recording region, and hence the coordinate system, instead, based on this fixed coordinate system, the object in the camera image is displayed displaced relative to the diagnostic image. In such a case, therefore, the first and second virtual mark are further displayed, based on the coordinate system, at the same locations or locations corresponding to one another in both images, wherein, however, these locations can display or represent different points of the real object. Accordingly, a comparison of the two images, i.e. the diagnostic image and the camera image, taking into account the virtual marks, can be used to determine any change in position of the object.

Alternatively, it can be provided that the camera image is superimposed on the diagnostic image and accordingly the virtual mark is displayed in the superimposition of the two images, i.e. in both images. The superimposition enables the deviation between the diagnostic image and the camera image to be determined and read directly and in a particularly simple way.

The first alternative, with which the diagnostic image and the camera image can be displayed, in particular independently of one another, for example on different screens, has the advantage that the identifiability of the respective representations is not impaired. Therefore, this enables the respective therapist or technician to assess the situation or the deviation in a particularly simple, accurate and reliable manner.

The second alternative, with which the two images are superimposed, advantageously enables both images and the deviation to be recorded jointly, i.e. in one frame, in particular simultaneously. While, therefore, the first virtual mark in the diagnostic image indicates a desired or intended location at which the real object is to be marked, the first virtual mark in the camera image or the second virtual mark in the camera indicates an actual location on which, for example, a marking facility, in particular for example a marking laser, is aligned in the current position of the object.

Therefore, this actual location or marking location would be marked in the current position by the marking facility actually on the real object if the deviation were not compensated. Compensation of the deviation can be achieved in that the actual marking location is brought into conformity with the setpoint location—for example by moving or realigning the object, the object holder and/or the marking facility.

In a further advantageous embodiment of the present invention, the diagnostic image is generated from a temporal sequence of scan data. The temporal sequence of scan data can, therefore, for example be a sequence of images recorded in succession, i.e. individual images of the object, wherein these individual images can be recorded from the same perspective or, for example, from different angles.

Furthermore, herein it is provided that, in addition to the one camera image, a plurality of further camera images of the object is recorded. This plurality of further camera images can, for example, be individual frames of a video sequence or a video stream. Furthermore, herein it is provided that the items of scan data are in each case assigned to one of the camera images (binning) in accordance with their temporal correlation with respective recording times of the plurality of camera images. Therefore, this enables a correlation or assignment to be achieved between the camera images and the individual images in the sequence of scan data. This, for example, enables account to be taken of movements or changes in position of the patient that occur during the acquisition or recording of the temporal sequence of scan data.

Herein, preferably the plurality of camera images enables a movement or change in position of the patient or a surface of the patient to be tracked. In this way, it is particularly simple, for example, to determine from the camera images a respiratory curve, i.e. the periodic movement of the patient induced by respiratory motions. The respiratory motion or respiratory curve of the patient can, for example, be particularly relevant if this movement also causes a movement or change in a spatial position or site of a therapeutically relevant region of the patient, for example an internal tumor or the like. The assignment between the individual images in the sequence of scan data to the camera images or the respiratory curve can facilitate and enhance understanding of the position, site and movement of such a region and accordingly also subsequent treatment or treatment planning, since, for example, more precise irradiation of the relevant region is enabled.

For example, the assignment can be used to determine an optimal irradiation time in relation to the respiratory curve, i.e. the ultimately unavoidable movement of the patient. Accordingly it is, for example, possible to synchronize therapeutic irradiation of the patient with the respiratory curve thereof so that, for example, the relevant region is in each case only irradiated during a respiratory maximum and/or a respiratory minimum and other regions are not exposed unnecessarily. This can, for example, achieve an improved treatment outcome and/or a reduced dose exposure of the patient.

The method according to at least one embodiment of the invention advantageously enables this with a particularly low outlay since here it is only necessary to use the scan data that is anyway recorded and the camera. Contrary to the case with conventional known methods, the method suggested in the present case therefore enables, for example, a belt provided to record a respiratory curve or physical marking elements on the patient to be dispensed with. This can increase patient comfort and reduce the error rate, for example due to incorrect operation or arrangement of the belt or the marking elements.

Contrary to the case with conventional known methods, there is, for example, also no need for any other further system thus enabling reduced outlay on equipment, installation, maintenance and data processing. Other conventional methods, such as, for example, SmartDeviceless 4D from General Electric, use, for example, a fluoroscopy scan, which can also be dispensed with in the method suggested in the present case, thus advantageously enabling the patient's exposure to radiation to be reduced. Contrary to the case with the use of a fluoroscopy scan, the present method also advantageously, for example, does not require the patient to breathe continuously or uniformly.

Moreover, it is advantageously possible, for example, to dispense with data import from the belt or the other system. With the present method, real data are advantageously available for the entire scan, i.e. for the period of the recording of the temporal sequence of scan data so that extrapolation from a limited data set of measured values is not necessary, thus enabling enhanced precision and reliability and reduced probability of error.

In an advantageous embodiment of the present invention, a position of an auxiliary object in operative connection with the object is determined using, i.e. based on, the diagnostic image and/or the camera image. This determined position of the auxiliary object or corresponding items of position data are then stored. The auxiliary object can, for example, be a mounting aid supporting or holding the object. The determination of this position of the auxiliary object and the storage of corresponding items of position data, which indicate the determined position, advantageously facilitates reproducibility of the position or site of the object. Herein, the items of position data can indicate the position of the auxiliary object for example relative to the image-generating facility, relative to the camera, relative to a joint coordinate system and/or relative to the object.

In an example embodiment of the invention, the determined and stored position of the auxiliary object is retrieved for the positioning of the object for a subsequent examination or manipulation of the object, for example from a corresponding storage facility. In other words, therefore, the position determined can, for example, be stored in a patient record or patient file or another kind of database and is then advantageously available whenever desired. This, for example, enables or facilitates enhanced reproducibility in the positioning of the object, for example in the scan position originally used.

Herein, it can be provided that the position of the auxiliary object is automatically retrieved and/or automatically displayed, for example in the form of a visual mark, in particular in virtual or augmented reality. It can also be provided that the auxiliary object or a functionally corresponding second auxiliary object is automatically moved into the retrieved position or a corresponding position—for example relative to the patient. Overall, this can reduce the error rate when positioning the object.

Advantageously, this embodiment of the method can, for example, be used when, after being marked within the context of the method according to the invention, the patient is arranged or aligned or is to be arranged or aligned, for example for the performance of irradiation, in a position or site, which ideally corresponds to the scan position. Herein, the irradiation can in particular be performed on a device different from the device used to generate the diagnostic image. It is also possible for this same position of the object to be reliably reproduced, for example for a plurality of temporally spaced irradiation procedures. This advantageously enables particularly precise and consistent therapy and hence for example an improved treatment outcome with simultaneously reduced exposure to radiation. Herein, particularly advantageously, no additional outlay on equipment devices or measurements is required since here it is again possible to use the data or images that are recorded anyway.

It can also, for example be possible to correlate or compare the retrieved position data with a new camera image, which is recorded on the device currently being used in each case, for example on the irradiation device.

A system according to at least one embodiment of the invention for recording a change in position of an object comprises a control device, an image-generating facility, a camera and a data-processing facility. Herein, the camera is arranged in a specified spatial positional relationship to the image-generating facility. The control device is configured to control the image-generating facility for the generation of a diagnostic image of the object in a scan position with an imaging medical method. The control device is furthermore configured to control the camera for the recording of a camera image of the object in a current position after the generation of the diagnostic image. The control device is furthermore configured to control the data-processing facility for the determination of a deviation of the current position of the object from a setpoint position defined relative to the scan position by correlation of the diagnostic image and the camera image.

The properties and developments of the method according to at least one embodiment of the invention disclosed above and in the following and the corresponding advantages can in each case be transferred analogously to the system according to the invention and/or to the components and facilities that are or can be used to carry out the method according to the invention and vice versa. Therefore, the invention also includes developments of the method according to the invention and the system according to the invention with embodiments, which are not described explicitly here in the respective combination.

The example embodiments explained in the following are preferred embodiments of the invention. In the example embodiments, the described components of the embodiments in each case represent individual features of the invention to be considered independently of one another, which in each case develop the invention, including independently of one another, and hence are also to be treated as part of the invention including individually or in a different combination than that shown. In addition, the described embodiments can also be expanded by further of the above-described features of the invention.

In the figures, the same, functionally equivalent or mutually corresponding elements are in each case given the same reference numbers.

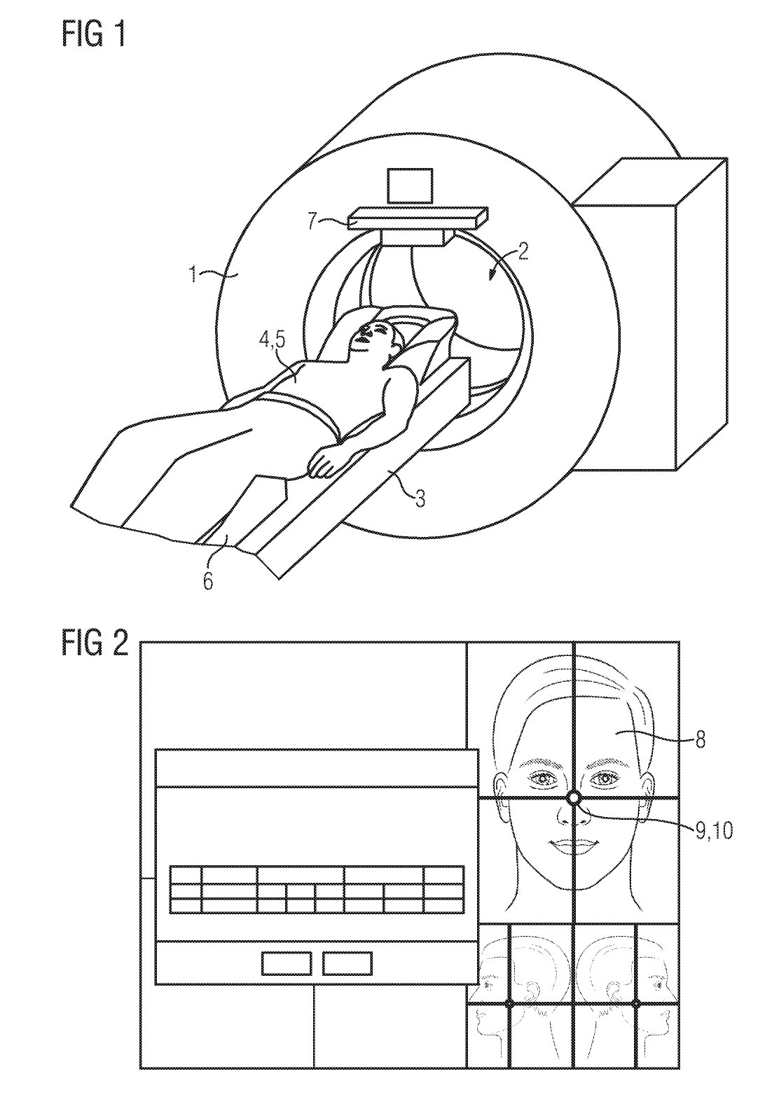

FIG. 1 shows a schematic and sectional perspective view of a computed tomograph 1 surrounding a scan region 2 in a ring shape. A patient bench 3 which is also represented here can be moved automatically into this scan region 2 and out of this scan region 2. In the present case, a patient 4 is located on the patient bed 3 in a scan position 5. To mount or support the patient 4 in this scan position 5, a mounting aid 6 that supports the patient 4 is arranged in regions between the patient 4 and the patient bench 3. Furthermore, in the present case, a camera 7 is arranged above the scan region 2 on the computed tomograph 1; in the present case, this is a stereoscopic or 3D camera. Therefore, the camera 7 can record three-dimensional images, in particular of the patient 4.

Based on the situation represented in FIG. 1, the following now explains a method for recording a change in position of the patient 4.

When the patient 4 has been arranged in the scan position 5, the patient bench 3 with the patient 4 located thereupon is moved wholly or partially into the scan region 5. The computed tomograph 1 then acquires or records or generates scan data of the patient 4. It is then possible to reconstruct a virtual three-dimensional representation of the patient 4 or a subregion of the patient 4 recorded with the computed tomograph 1 from this scan data. To this end, it is possible to use a data-processing facility, for example a computer, which is not represented here. Therefore, the computed tomograph 1 or the computed tomograph 1 together with the data-processing facility form an image-generating facility for the generation of a diagnostic image 16 (see FIG. 4) of the patient 4.

Therefore, a scan representation 8 of the patient 4, which is represented schematically in FIG. 2, is generated automatically from the scan data recorded via the computed tomograph, wherein said scan representation can, for example, be evaluated by a respective therapist. In the present example, it is planned that the patient 4 should be given irradiation treatment. To this end, the therapist specifies a first virtual mark 9 in the scan representation 8 by which a setpoint location 10 is marked. Here, the setpoint location 10 can indicate the location on or in the patient 4 at which the irradiation treatment is to take effect. However, the setpoint location 10 can alternatively or additionally be a location at which a mark for the later verification of a position or posture of the patient 4 is to be applied. The setpoint location 10 can also be an anatomically stable reference point on the patient—for example at or on an iliac crest located in a known spatial relationship to a location to be actually irradiated or marked.

Since the irradiation treatment is not performed via the computed tomograph 1, but, for example, via a linear accelerator or a proton therapy facility and there can be a considerable time gap between the recording of the scan data via the computed tomograph 1 and the irradiation treatment, it is necessary to ensure that the intended setpoint location can be found again in a reliable and reproducible manner. To this end, it is provided that a corresponding permanent mark, for example a tattoo or the like, is applied to the patient 4. Herein, it is difficult or problematic to ensure that this tattoo actually marks the intended setpoint location 10.

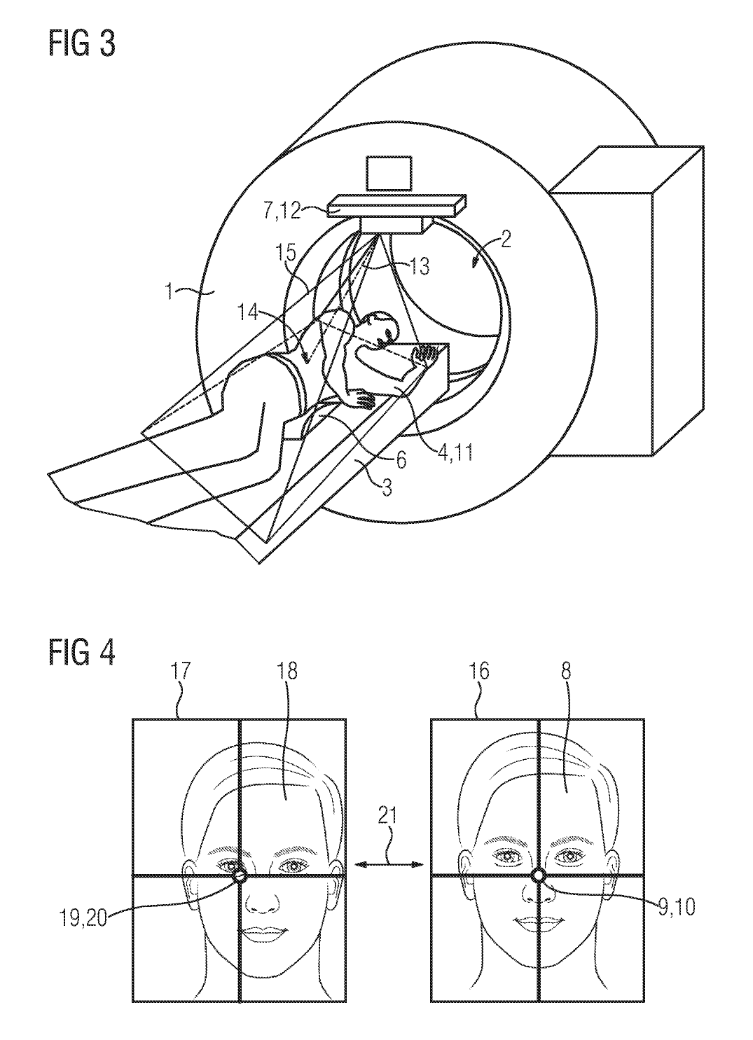

FIG. 3 is a schematic depiction of a situation similar to the situation already shown in FIG. 1. In the situation shown in FIG. 3, the patient bench 3 has been moved out of the scan region 2 again after the recording of the scan data. Since there has been a certain time gap between the situations shown in FIG. 1 and FIG. 3, the patient has moved in the interim and in FIG. 3 is now in a current position 11, which in particular can be different from the scan position 5.

To resolve this problem in that the patient does not necessarily remain motionless, in the present case it is provided that a marking facility, in particular controlled by the data-processing facility or a control device connected thereto, automatically displays the location to be marked on the patient. In the present case, to this end, a marking laser 12 is provided on the camera 7 and emits a laser beam 13. Herein, the marking laser 12 is controlled such that a marking location 14 indicated by the laser beam 13 on the patient 4 indicates or marks precisely the virtually specified setpoint location 10 in the scan representation if the patient has not moved. However, here there is the further problem that, due to the computing-intensive and time-consuming generation of the scan representation 8, there can be a significant time gap between the recording of the scan data and the necessary evaluation by the therapist—for example 5 to 20 minutes. In order to make this waiting time more comfortable for the patient 4, the patient bench 3 is moved out of the scan region 2 again after the recording of the scan data. During this waiting time, the patient 4 can move, i.e. change position. Accordingly, the current position 11 of the patient 4 can differ from the scan position 5.

In order to tackle this further problem, it is provided in the present case that the camera 7, the recording region 15 of which is indicated schematically here, records a camera image 17 (see FIG. 4) before the application of the tattoo. Since the camera 7 is located, i.e. is arranged, in a known spatial positional relationship to the computed tomograph 1, there is also a known positional relationship or relation between the recording region 15 or the camera image 17 and the diagnostic image 16.

FIG. 4 shows a schematic comparison of the diagnostic image 16 with the scan representation 8 and the first virtual mark 9 on the one hand and of the camera image 17 with a camera representation 18 of the patient 4 in the current position 11. Due to the known relationship between the diagnostic image 16 and the camera image 17, a second virtual mark 19 can be displayed in the camera image 17 with a position within the camera image 17 corresponding to the position of the first virtual mark 9 in the diagnostic image 16. In addition, the second virtual mark 19 also indicates the marking location 14 with which the marking laser 12 or the laser beam 13 is aligned. If the patient 4 has moved between the time of the recording of the scan data and the time of the recording of the camera image 17, a location 20 in the camera representation 18 marked by the second virtual mark 19 no longer corresponds to the setpoint location 10 based on the real patient 4.

This deviation between the location 20 marked in the camera image 17 and the setpoint location 10 is determined by a schematically indicated correlation 21 between the diagnostic image 16 and the camera image 17. To this end, it is, for example, possible to calculate a difference between the diagnostic image 16 and the camera image 17. If the deviation determined in this way is greater than zero, this causes the change in position of the patient between the scan position 5 and the current position 11 to be recorded or determined. To compensate the deviation, it is, for example, possible for the patient bench 3 to be automatically moved or adjusted and/or for the marking laser 12 to be automatically realigned. This enables it to be ensured that the location 20 marked in the camera image 17 indicates or marks the same location of the patient 4 as the first virtual mark 9 in the diagnostic image 16. This means that then therefore the real marking location 14 on the patient 4 corresponds to the setpoint location 10 specified by the first virtual mark 9.

Overall, this enables a change in position of an object, i.e. here the patient 4, to be recorded reliably and automatically compensated with a particularly low outlay.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for determining a deviation in position of an object, the method comprising:
generating a diagnostic image of the object in a scan position with an imaging medical method;
recording of a camera image of the object in a current position from a perspective with a specified spatial positional relationship to the diagnostic image after the generating of the diagnostic image; and
determining a deviation of a current position of the object from a setpoint position, defined relative to the scan position by correlation of the diagnostic image and the camera image.

2. The method of claim 1, wherein the generating of the diagnostic image includes recording a three-dimensional scan data of the object and performing a virtual three-dimensional reconstruction based on the scan data and wherein the camera image is recorded as a 3D image of the object.

3. The method of claim 1, wherein the recording of the camera image includes recording of a plurality of camera images of the object and wherein the deviation is determined continuously by correlation of the diagnostic image and the plurality of camera images recorded.

4. The method of claim 1, wherein the deviation determined is automatically compensated.

5. The method as claimed in claim 4, wherein the deviation is only automatically compensated upon exceeding a specified threshold value.

6. The method of claim 1, further comprising:
recording a first virtual mark in the diagnostic image, the first virtual mark indicating a specified setpoint location for a real mark on the object in a coordinate system of the diagnostic image; and
aligning the camera image on a same or a corresponding coordinate system, wherein
a second virtual mark is displayed at a location of the first virtual mark in the coordinate system or
the camera image is superimposed on the diagnostic image and the first virtual mark is displayed in a superimposition of the camera image and diagnostic image.

7. The method of claim 1, wherein the diagnostic image is generated from a temporal sequence of scan data, wherein the recording of the camera image includes recording a plurality of camera images of the object and wherein each item of the scan data is respectively assigned to one of the plurality of camera images in accordance with a temporal correlation with respective recording times of the respective plurality of camera images.

8. The method of claim 1, wherein at least one of the diagnostic image and the camera image is used to determine a position of an auxiliary object in operative connection with the object and corresponding items of position data are stored.

9. The method as claimed in claim 8, wherein the determined and stored position of the auxiliary object is retrieved for the positioning of the subsequent examination or manipulation of the object.

10. A system for controlling a data processing facility, the system comprising:
a control device;
an image-generating facility;
a camera arranged in a specified spatial positional relationship to the image-generating facility and a data-processing facility, wherein the control device is configured to
control the image-generating facility for generation of a diagnostic image of an object in a scan position with an imaging medical method,
control the camera for recording of a camera image of the object in a current position after the generation of the diagnostic image, and
control the data-processing facility for determination of a deviation of the current position of the object from a setpoint position defined relative to the scan position by a comparison of the diagnostic image and the camera image.

11. The method of claim 3, wherein the plurality of camera images include a video sequence of the object, and wherein the deviation is determined continuously by correlation of the diagnostic image and the video sequence of the object.

12. The method of claim 2, wherein the recording of the camera image includes recording of a plurality of camera images of the object and wherein the deviation is determined continuously by correlation of the diagnostic image and the plurality of camera images recorded.

13. The method of claim 12, wherein the plurality of camera images include a video sequence of the object, and wherein the deviation is determined continuously by correlation of the diagnostic image and the video sequence of the object.

14. The method of claim 4, wherein the deviation determined is automatically compensated by moving at least one of an object holder supporting the object and a marking facility for marking the object as a function of the deviation determined.

15. The method as claimed in claim 14, wherein the deviation is only automatically compensated upon exceeding a specified threshold value.

16. The method of claim 2, further comprising:
recording a first virtual mark in the diagnostic image, the first virtual mark indicating a specified setpoint location for a real mark on the object in a coordinate system of the diagnostic image; and
aligning the camera image on a same or a corresponding coordinate system, wherein
a second virtual mark is displayed at a location of the first virtual mark in the coordinate system or
the camera image is superimposed on the diagnostic image and the first virtual mark is displayed in a superimposition of the camera image and diagnostic image.

17. The method of claim 3, further comprising:
recording a first virtual mark in the diagnostic image, the first virtual mark indicating a specified setpoint location for a real mark on the object in a coordinate system of the diagnostic image; and
aligning the camera image on a same or a corresponding coordinate system, wherein
a second virtual mark is displayed at a location of the first virtual mark in the coordinate system or
the camera image is superimposed on the diagnostic image and the first virtual mark is displayed in a superimposition of the camera image and diagnostic image.

18. The method of claim 2, wherein the diagnostic image is generated from a temporal sequence of scan data, wherein the recording of the camera image includes recording a plurality of camera images of the object and wherein each item of the scan data is respectively assigned to one of the plurality of camera images in accordance with a temporal correlation with respective recording times of the respective plurality of camera images.

19. The method of claim 8, wherein the auxiliary object is a mounting aid.
